(19) United States
(12) Patent Application Publication
(10) Pub. No.: US 2008/0134308 A1
(43) Pub. Date: Jun. 5, 2008

(54) Network login security

(76) Inventors: Ramachandra Yalakanti, Roseville, CA (US); Charles A. Black, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/633,744

(22) Filed: Dec. 5, 2006

(51) Int. Cl. H04L 9/32

(52) U.S. Cl. 726/6

(57) ABSTRACT

Systems, methodologies, media, and other embodiments associated with network login security are described. One exemplary system embodiment includes a network edge logic configured to receive information related to a network login request, to gather information associated with the user, and, to gather information related to the user's system. The system further includes a server comprising an identity management agent configured to determine access rights to a network based on the user login request, gathered information associated with the user, gathered information related to the user's system, and, stored access profile information.

### BACKGROUND

Conventionally, network login security has focused on presentation of credentials such as a user name/identifier and password. The credentials can be presented to a remote authentication dial-in user service (RADIUS). Based on the credentials presented, a RADIUS server can regulate access to a network.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example identity management system.

FIG. 2 illustrates another example identity management system.

FIG. 3 illustrates an example access profile.

FIG. 4 illustrates an example user interface.

FIG. 5 illustrates another example user interface.

FIG. 6 illustrates another example user interface.

FIG. 7 illustrates an example method for assigning network access rights.

FIG. 8 illustrates an example computing environment in which example systems and methods illustrated herein can operate.

### DETAILED DESCRIPTION

Example systems, methods, media, and other embodiments described herein relate to network login security. In one example, a system comprises a network edge logic configured to receive information related to a network login request. The network edge logic gathers information associated with the user and/or information related to the user's system. The system further includes a server comprising an identity management agent configured to determine access rights to a network based on the user login request, gathered information associated with the user, gathered information related to the user's system, and, stored access profile information.

In one example, the identity management system facilitates regulation of access to the network and/or resources of the network (e.g., web page(s), application(s), stored data and the like). The identity management system can provide variable access rights to a user based on certain criterion, as discussed below.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Application”, as used herein, refers to a set of related computer-executable instructions that may be executed on a computer to achieve a defined goal. An application may be a stand-alone application, a distributed application, a client-server application, and so on. An operating system is not an application in the context of this patent application. An application may have interface logic and business logic that may be distributed on different computers.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, semiconductor memories, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a hard disk, a magnetic tape, other magnetic medium, a CD-ROM, other optical medium, a RAM (random access memory), a ROM (read only memory), an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

A “server”, as used herein, refers to a computer component configured to perform a defined function. While a server may include both hardware and software, as used herein, server typically refers to software configured to perform a defined function. For example, the term “web server” refers to software configured to provide web services rather than the machine (e.g., computer) upon which the web server runs. As described above, the functionality of a server may be extended by the addition of a servlet. Thus, a server may include a “servlet runner”. A servlet runner may be configured to control (e.g., load, start, stop, unload) servlets. A servlet runner may also be configured to listen at servlet ports and to selectively communicate with a servlet. One example servlet runner is provided by an Apache Web Server.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may dependent, for example, on requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Software suitable for implementing the various components of the example systems and methods described herein may include software produced using programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

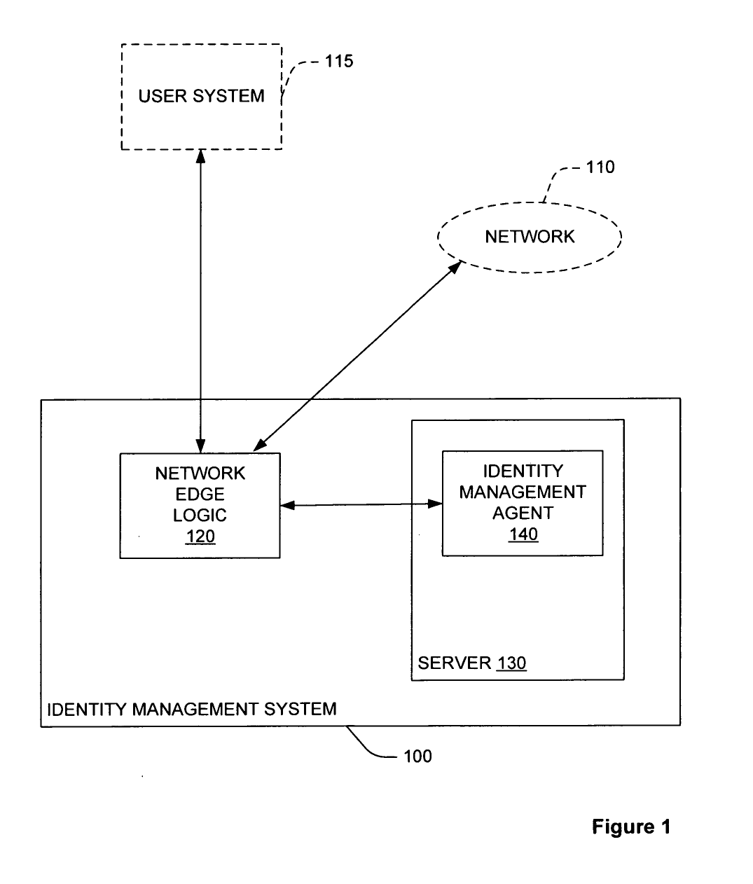

FIG. 1 illustrates an identity management system 100 that facilitates regulation of access to a network 110 and/or resources of the network 110 (e.g., web page(s), application(s), stored data and the like). In one example, the identity management system 100 can provide variable access rights to a user based on one or more of the following:

1. the identity of the user;

2. the group membership of the user;

3. the location from which the user is accessing the network 110;

4. the time at which the user is accessing the network 110; and/or

5. information associated with a user system 115 from which the user is accessing the network.

As noted previously, conventional network login security systems have focused on the presentation of credentials such as a user name/identifier and password. With the system 100, an administrator can control access to the network 110 and/or resource(s) of the network 110 (e.g., applications) based, for example, on the identity of the user, information associated with the user, information associated with the user's system and/or temporal information and stored access profile information. Based on this information, the identity management system 100 can permit, reject and/or regulate permission of particular to user to the network 110 and/or particular resources of the network 110.

In one embodiment, the identity management system 100 facilitates identity-based management which administers and controls access not only to systems and applications, but to the very network 110. The identity management system 100 facilitates control of user access at the edge of the network 110. For example, unauthorized users can be rejected at the perimeter of the network 110, before they can begin to create mischief that might harm servers and network infrastructure devices using denial-of-service and other malicious attacks. Thus, the identity management system 100 can protect the network 110 from intentional and/or unintentional attacks by moderating the access rights of the users that are granted access to the network 110.

The identity management system 100 includes a network edge logic 120, for example, a switch and/or access point. The identify management system 100 further includes a server 130 (e.g., RADIUS server) having an identity management agent 140.

The network edge logic 120 can gather user credential(s), information related to the user and/or information related to the user system 115. For example, the network edge logic 120 can employ the IEEE 802.1X standard with smartcards and/or certificates to obtain information regarding the user and/or user's system 115. Additionally, the network edge logic 120 can gather credential information via a web-based mechanism for obtaining username and/or password. Finally, the network edge logic 120 can obtain information related to the user system 115 such as the user's system 115 Media Access Control (MAC) address. Thereafter, the network edge logic 120 can provide the information obtained regarding the user and/or user's system 115 to the identity management agent 140.

In one example, the identity management agent 140 maintains information regarding access policy(ies) received from an identity management configuration system (not shown), as discussed in greater detail below. Based on the access policy(ies), the information regarding the user (e.g., identity of the user and/or group membership of the user) and/or information regarding user's system 115 (e.g., location from which the user is accessing the network 110 and/or the system from which the user is accessing the network) received from the network edge logic 120, and/or temporal information (e.g., time and/or date), the identity management agent 140 can determine whether the user is permitted to use the network, and, if so, which resource(s) of the network 110 the user is permitted to use.

Thus, the identity management agent 140 can assign appropriate access rights to the user. In one example, these access rights are applied at the edge of the network 110 (via the network edge logic 120), where the user connects. By applying this information at the edge, the effect can be realized immediately at the point of entry and throughout the network 110 as well. This results in the dynamic configuration of the network edge logic 120 with the appropriate access rights for the user.

The access rights can include, for example, access to a virtual local area network (VLAN), quality of service, prioritization of network traffic, and/or rate limits (the amount of traffic the user can introduce into the network 110). Further, the identity management agent 140 can employ granular value(s) for access rights for permitted and/or denied resource(s) (e.g., target devices and/or applications etc.).

In one embodiment, the identity management system 100 can build upon existing security and/or networking framework/standards (e.g., de facto and/or issued). Conventionally, the remote authentication dial-in user service (RADIUS) has been the established authentication standard for remote access, originally in the area of dial-up access. Recently, RADIUS has become the de facto standard authentication standard for virtual private network (VPN), wireless, and/or wired access as well.

In this embodiment, the identity management system 100 can be built on top of this existing security infrastructure by running in conjunction with the RADIUS server. For example, when a user's authentication request arrives, the identity management system 100 can determine the appropriate access rights, if any, for the user. Those rights can be passed back with the authentication reply, and applied by the network edge logic 120 (switch or access point).

Additionally, in one example, the identity management system 100 can work in conjunction with existing identity-based directory services such as Active Directory. Accordingly, in this example, the existing infrastructure for security at the edge is preserved intact, and is enhanced by adding the adaptive capabilities of automatically configuring the network edge logic 120 based on the appropriate access rights of the user.

In one embodiment, the identity management system 100 can include a plurality of servers 130, with each server 130 having an identity management agent 140. This can facilitate high availability by running on multiple redundant servers 130 (e.g., RADIUS servers). Additionally, reliability can be increased as a centralized identity management configuration logic (discussed below) is not necessary in order to determine access rights.

The end result from a user's perspective is that the user's access rights follow the user. Variable access rights are delivered to users based on who they are, where they are located and/or the means by which they are attempting to connect to the network 110.

For example, a “guest user” can be given to a lobby area only during work hours and/or the guest user can be placed into an isolated area of the network (e.g., safely away from intranet). Additionally, traffic associated with the guest user can be given a low priority and the volume associated with the guest user regulated.

Further, group member characteristic(s) of the user (e.g., student or faculty) can be employed to determine the user's access rights. For example, the system 100 can separate students from faculty, no matter where they log in to the network 110.

Further, temporal information can be employed to block access to the network 110, for example, once a user's privileges have expired (e.g., contractor no longer employed with entity). For example, the system 100 can allow contractors to get access only for the duration of time that they are employed, and no access from that point onward. Additionally certain user(s) can enjoy greater bandwidth and be given higher priority as their traffic traverses the network 110.

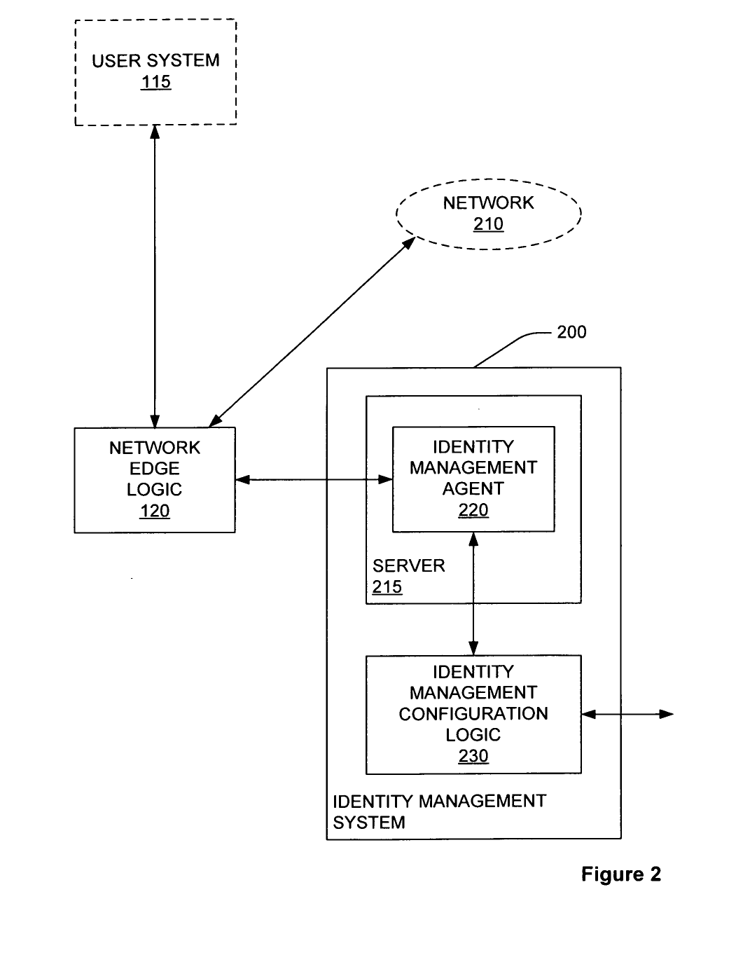

FIG. 2 illustrates an identity management system 200 that facilitates regulation of access to a network 210 and/or resources of the network 210 (e.g., web page(s), application(s), stored data and the like). The identity management system 200 can provide variable access rights as discussed previously.

The identity management system 200 includes one or more servers 215 with each server having an identity management agent 220. In one example, the identity management agent 220 performs substantially similar to the identity management agent 140 discussed above.

The identity management system 200 further includes an identity management configuration logic 230 configured to manage access to the network 210 and/or resources of the network 210. In one example, an administrator can alter access profile(s) via the identity management configuration logic 230 (e.g., using user interface(s) as described below). Thereafter, the identity management configuration logic 230 can provide the modified access profile(s) to the identity management agent(s) 220.

For example, an entity (e.g., corporation, manufacturing plant, university etc.) can have a business requirement to prevent and/or limit network access during a certain period of time (e.g., holiday period, non-business hours). A further business requirement can be based on a user's work schedule, for example, user only permitted to access network 210 and/or particular resource(s) of the network 210 during a certain time period.

The identity management agent 220 can authorize a network 210 login request based upon rule(s) established by the network administrator received via the identity management configuration logic 230. The rule(s) can be based, for example, upon user, time and/or location constraints. For example, the network administrator can set up network login policies based on the combination of user, group of user, user work schedules, user locations and corporate holiday schedules. Further, the work schedules can vary between user to user and also can be complex enough to deal with multiple time spans including, for example, start/end date ranges, weekday selections, various time and corporate holiday schedule inclusions.

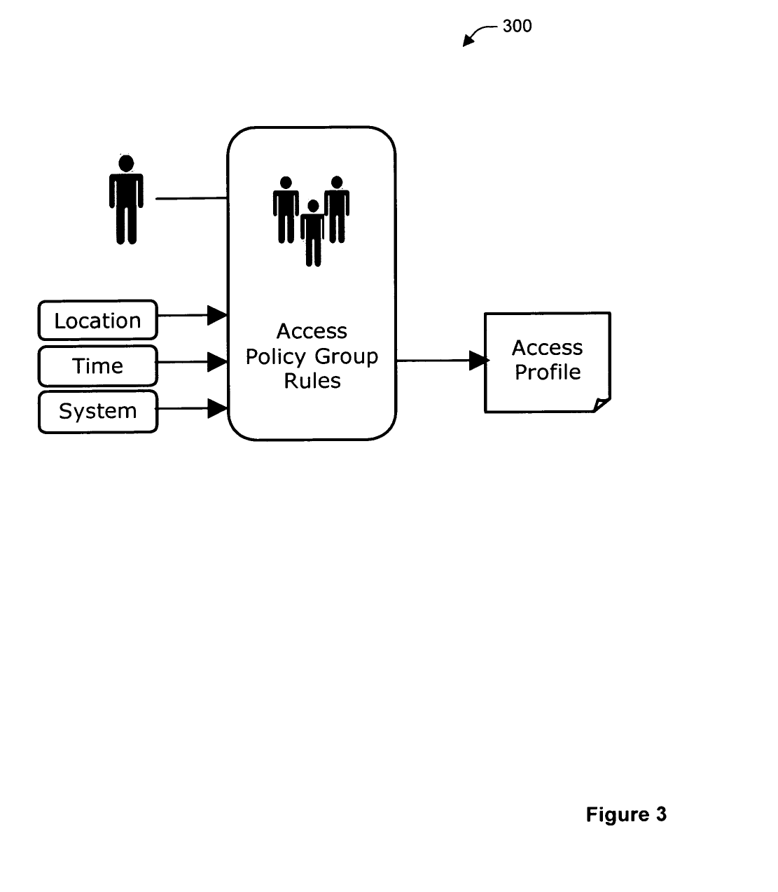

FIG. 3 illustrates an access profile diagram 300. In this example, user, group, location, time, and system are combined in the form of access policy group rules, which are evaluated in order to determine the appropriate access profile (e.g., access rights) to be assigned to the user.

As illustrated in the diagram 300, an access profile can be based upon an access policy group rules. The access policy group rules can be based, for example, upon a user, a location, time and/or user system (e.g., wired, wireless etc.). Based upon the access profile, information associated with the user, information associated with the user's system and/or temporal information, the identity management agent 140, 220 can assign access rights (or deny access) to the user.

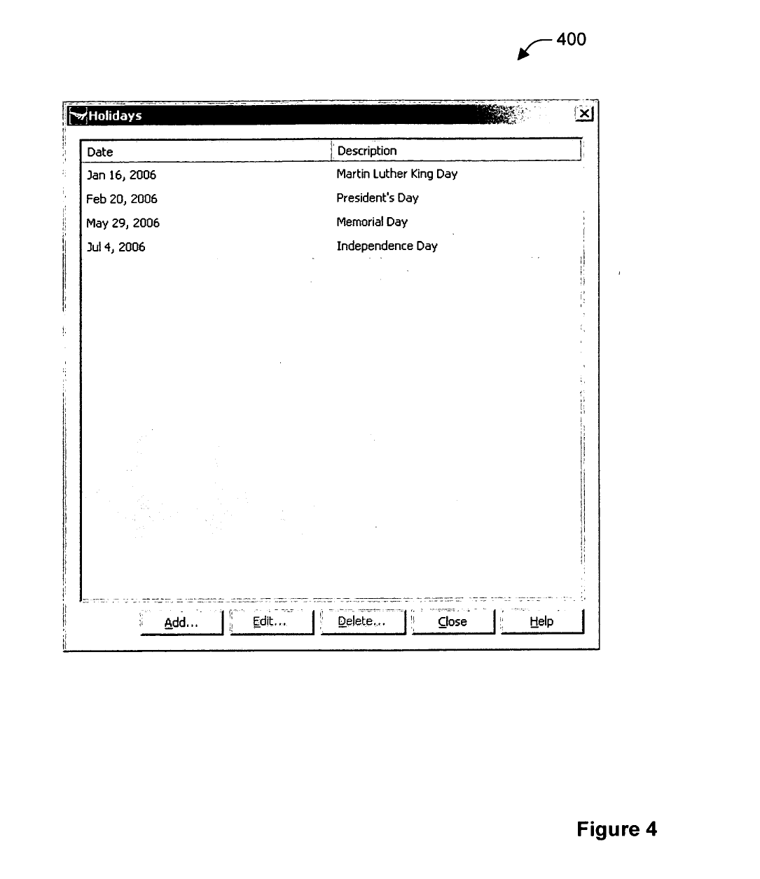

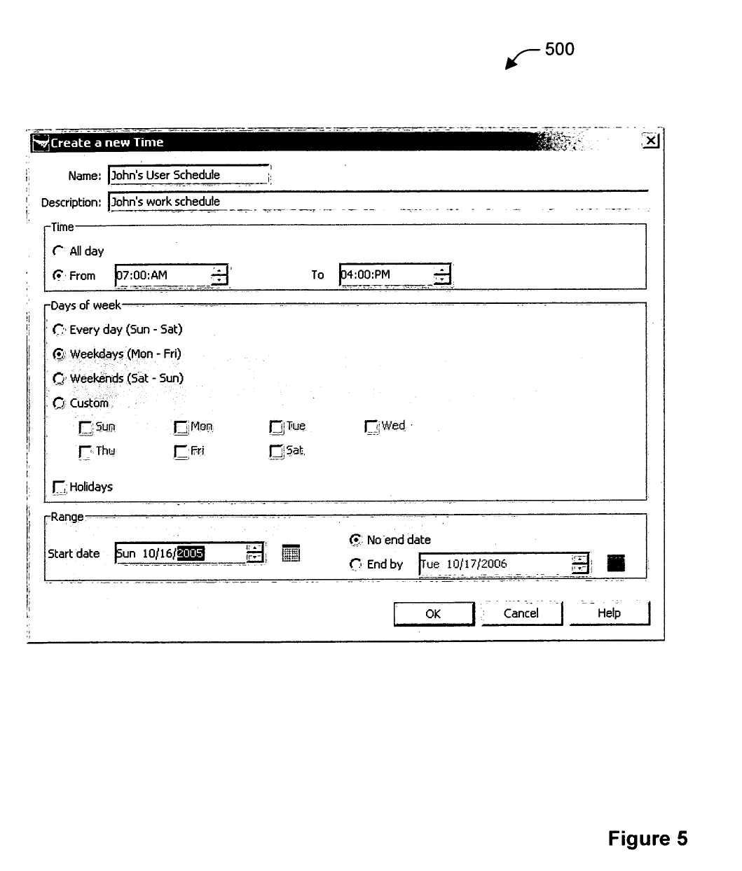

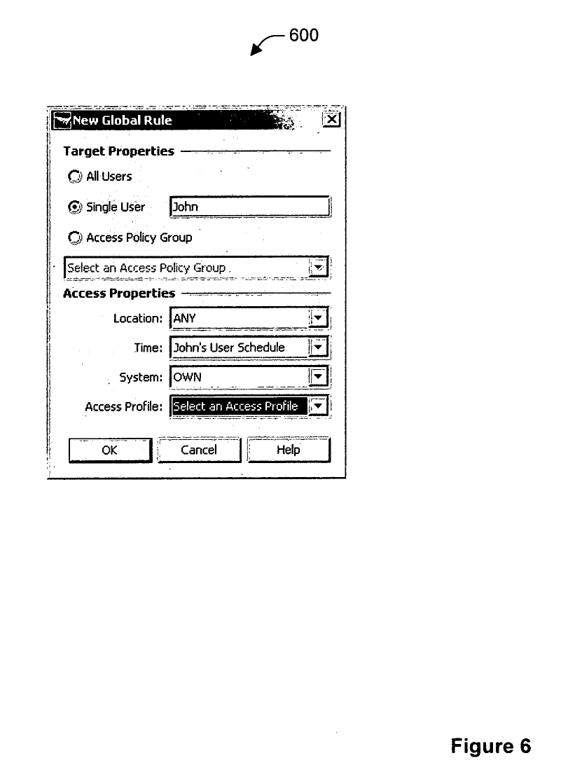

FIGS. 4-6 illustrate example user interfaces 400, 500, 600. For example, the user interfaces 400, 500, 600 can be employed with the identity management configuration logic 230 to create and/or modify access profile(s). For example, user interface 400 can be employed to create/modify a holiday schedule, user interface 500 can be employed create/modify a user's work schedule, and, user interface 600 can be employed to create/modify a global rule. More particularly, in the user interface 600, a global rule is shown which affects the single user “John” and applies at “ANY” location, applies “John's User Schedule” and system “OWN”.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various actions occurring in serial, it is to be appreciated that in different examples, various actions could occur concurrently, substantially in parallel, and/or at substantially different points in time.

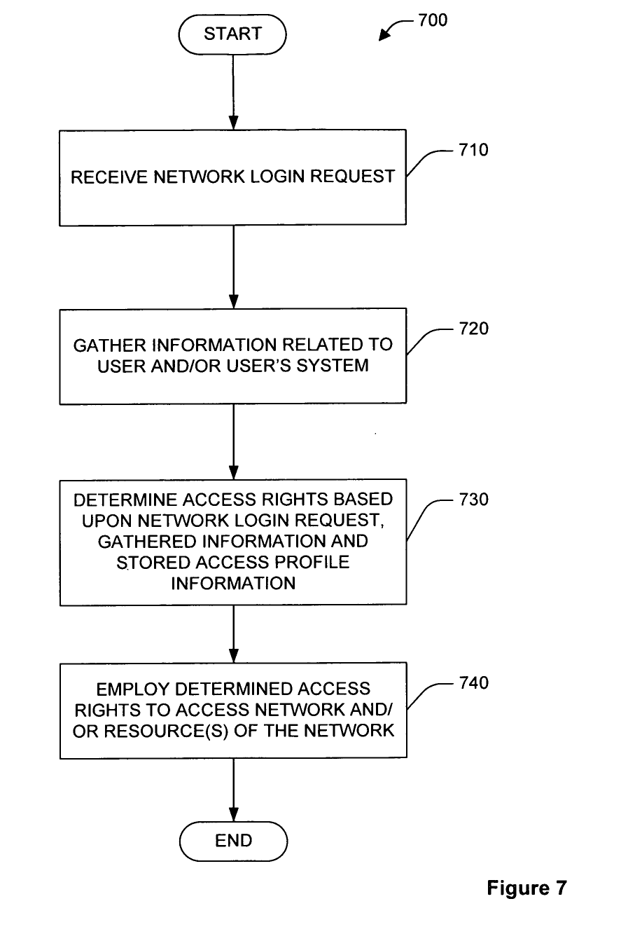

FIG. 7 illustrates an example methodology 700 associated with assigning network access rights. The illustrated elements denote “processing blocks” that may be implemented in logic. In one example, the processing blocks may represent executable instructions that cause a computer, processor, and/or logic device to respond, to perform an action(s), to change states, and/or to make decisions. Thus, described methodologies may be implemented as processor executable instructions and/or operations provided by a computer-readable medium. In another example, processing blocks may represent functions and/or actions performed by functionally equivalent circuits like an analog circuit, a digital signal processor circuit, an application specific integrated circuit (ASIC), or other logic device. FIG. 7, as well as the other figures, is not intended to limit the implementation of the described examples. Rather, the figures illustrate functional information one skilled in the art could use to design/fabricate circuits, generate software, or use a combination of hardware and software to perform the illustrated processing.

It will be appreciated that electronic and software applications may involve dynamic and flexible processes such that the illustrated blocks can be performed in other sequences different than the one shown and/or blocks may be combined or separated into multiple components. Blocks may also be performed concurrently, substantially in parallel, and/or at substantially different points in time. They may also be implemented using executable code produced using various programming approaches like machine language, procedural, object oriented and/or artificial intelligence techniques.

FIG. 7 illustrates a method for assigning network access rights 700. At 710, a network login request is received, for example, by a network edge logic 120. The network login request can include, for example, a user name/identifier, password and/or other credentials.

At 720, information related to the user and/or user's system is gathered (e.g., by the network edge logic 120). For example, the network edge logic 120 can obtain information related to the user system such as the user's system MAC address.

At 730, access rights are determined based upon the network login request, the gathered information and stored access profile information. At 740, the determined access rights are employed to access the network and/or resource(s) of the network, and, the method 700 ends.

While FIG. 7 illustrates various actions occurring in serial, it is to be appreciated that various actions illustrated in FIG. 7 could occur substantially in parallel. By way of illustration, a first process could receive a network login request. Similarly, a second process could gather information related to the user and/or user's system, while a third process could determine an access profile based upon the network login request and gathered information. While three processes are described, it is to be appreciated that a greater and/or lesser number of processes could be employed and that lightweight processes, regular processes, threads, and other approaches could be employed.

In one example, methodologies are implemented as processor executable instructions and/or operations stored on a computer-readable medium. Thus, in one example, a computer-readable medium may store processor executable instructions operable to perform a method that includes assigning network access rights. While the above method is described being stored on a computer-readable medium, it is to be appreciated that other example methods described herein can also be stored on a computer-readable medium.

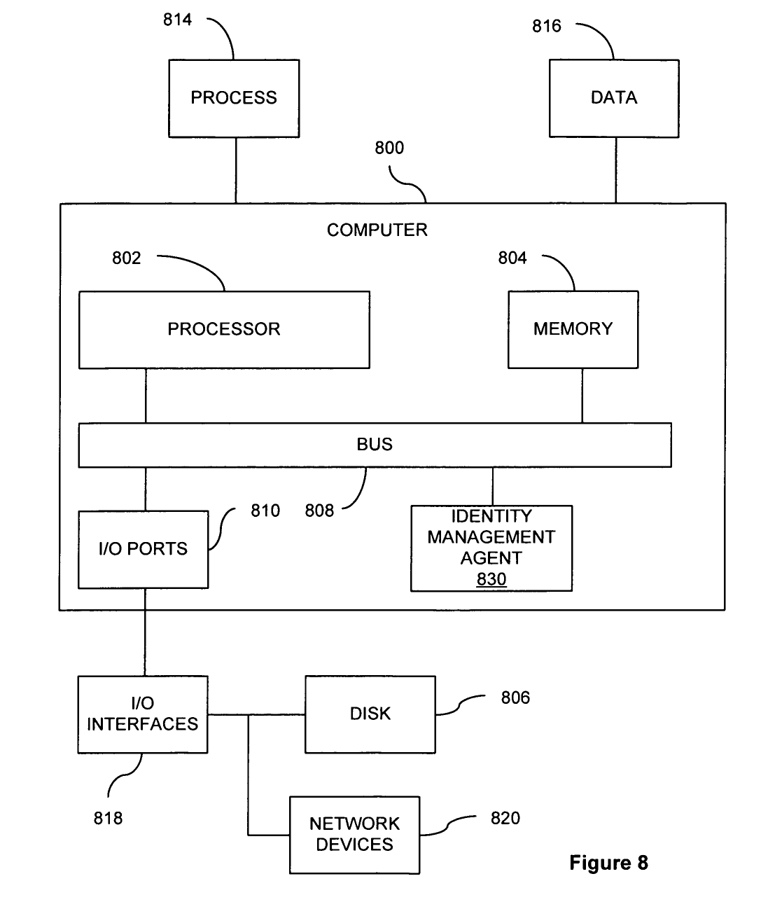

FIG. 8 illustrates an example computing device in which example systems and methods described herein, and equivalents, can operate. The example computing device may be a computer 800 that includes a processor 802, a memory 804, and input/output controllers 840 operably connected by a bus 808. In one example, the computer 800 may include an identity management agent 830 configured to facilitate determination of user access rights.

While identity management agent 830 is illustrated as a hardware component attached to bus 808, it is to be appreciated that in one example, identity management agent 830 could be implemented in software, stored on disk 806, brought into memory 804, and executed by processor 802.

Generally describing an example configuration of computer 800, processor 802 can be a variety of various processors including dual microprocessor and other multi-processor architectures. Memory 804 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 806 may be operably connected to computer 800 via, for example, an input/output interface (e.g., card, device) 818 and an input/output port 810. Disk 806 may be, for example, devices like a magnetic disk drive, a solid state disk drive, a floppy disk drive, a tape drive, a Zip drive, a flash memory card, and/or a memory stick. Furthermore, disk 806 may be devices like optical drives (e.g., a CD-ROM), a CD recordable drive (CD-R drive), a CD rewriteable drive (CD-RW drive), and/or a digital video ROM drive (DVD ROM). Memory 804 can store processes 814 and/or data 816, for example. Disk 806 and/or memory 804 can store an operating system that controls and allocates resources of computer 800.

Bus 808 may be a single internal bus interconnect architecture and/or other bus or mesh architectures. While a single bus is illustrated, it is to be appreciated computer 800 may communicate with various devices, logics, and peripherals using other busses that are not illustrated (e.g., PCIE, SATA, Infiniband, 1394, USB, Ethernet). Bus 808 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

Computer 800 may interact with input/output devices via i/o interfaces 818 and input/output ports 810. Input/output devices can include, but are not limited to, a keyboard, a microphone, a pointing and selection device, cameras, video cards, displays, disk 806, network devices 820, and the like. Input/output ports 810 may include but are not limited to, serial ports, parallel ports, and USB ports.

Computer 800 may operate in a network environment and thus may be connected to network devices 820 via i/o devices 818, and/or i/o ports 810. Through network devices 820, computer 800 may interact with a network. Through the network, computer 800 may be logically connected to remote computers. The networks with which computer 800 may interact include, but are not limited to, a local area network (LAN), a wide area network (WAN), and other networks. Network devices 820 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, network devices 820 can connect to WAN technologies including, but not limited to, point to point links, circuit switching networks like integrated services digital networks (ISDN), packet switching networks, and digital subscriber lines (DSL).

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A system, comprising:
a network edge logic configured to receive information related to a network login request, to gather information associated with the user, and, to gather information related to the user's system; and,
a server comprising an identity management agent configured to determine access rights to a network based on the user login request, gathered information associated with the user, gathered information related to the user's system, and, stored access profile information.

2. The system of claim 1, the identity management agent further configured to determine the access rights based on at least one of a time of day, a corporate holiday schedule and a user schedule associated with the network login request.

3. The system of claim 1, the identity management agent further configured to determine the access rights based on a stored group membership of the user.

4. The system of claim 1, the identity management agent further configured to determine the access rights based a physical location from which the user is attempting to access the network.

5. The system of claim 1, the gathered information related to the user's system comprising a media access control address of the user's system.

6. The system of claim 1, the identity management agent further configured to determine access rights to one or more particular resources of the network.

7. The system of claim 1, the stored access profile information received from an identity management configuration logic.

8. The system of claim 7, further comprising the identity management configuration logic configured to provide modified access profile information to the identity management agent.

9. The system of claim 1, comprising a plurality of servers, each server comprising an identity management agent.

10. The system of claim 1, the access rights include access to a virtual local area network.

11. The system of claim 1, the access rights include a quality of service to be provided to the user.

12. The system of claim 1, the access rights include prioritization of network traffic to be allocated to the user.

13. The system of claim 1, the access rights include access and/or rate limits to be allocated to the user.

14. The system of claim 1, the server is a remote authentication dial-in service.

15. A system, comprising:
means for receiving a network login request;
means for gathering information related to a user;
means for gather information related to the user's system;
means for determining access rights based upon the network login request and gathered information; and,
means for employing the determined access rights to access a network.

16. The system of claim 15, further comprising means for employing the determined access rights to access a particular resource of the network.

17. A method for assigning network access rights, comprising:
receiving a network login request;
gathering information related to the user and/or user's system; and,
determining access rights based upon the network login request, gathered information, and, stored access profile information.

18. The method of claim 17, further comprising employing the determined access profile to access the network.

19. The method of claim 17, further comprising employing the determined access profile to access a particular resource of the network.

20. The method of claim 17 being implemented by processor executable instructions provided by a machine-readable medium.
